(19) United States
(12) Patent Application Publication
(10) Pub. No.: US 2022/0188950 A1
(43) Pub. Date: Jun. 16, 2022

(54) SYSTEM AND METHOD OF SEMI-AUTOMATED DETERMINATION OF A VALUATION OF A PATENT APPLICATION OF AN ENTITY

(71) Applicant: Owners Capital GmbH, Munich (DE)

(72) Inventor: Michel Gschwendtner, Munich (DE)

(21) Appl. No.: 17/121,756

(22) Filed: Dec. 15, 2020

(51) Int. Cl. G06Q 50/18; G06N 20/00; G16Y 40/35; G16Y 40/50

(52) U.S. Cl. CPC G06Q 50/184; G16Y 40/50; G16Y 40/35; G06N 20/00

(57) ABSTRACT

Disclosed is a method for semi-automated determination of a valuation of a patent application of an entity using machine learning based on a dynamic representation of the patent application in at least one dimension, characterized in that the method comprises: generating a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation; generating a representation of the patent application in at least one dimension based on the at least one layer of information; training a machine learning model by comparing the at least one layer of the information for the patent application with corresponding layer of information for comparable patents; processing a user input from a user interaction with the at least one dimensional representation of the patent application; providing the user input as training data to refine the machine learning model; and dynamically updating a valuation of the patent application by applying a machine learning algorithm to the machine learning model.

### TECHNICAL FIELD

The present disclosure relates generally to a system and a method of semi-automated determination of a valuation of a patent application of an entity using machine learning based on a dynamic representation of the patent application in at least 3 dimensions; moreover, the aforesaid system employs, when in operation, machine learning techniques for determining the valuation of the patent.

### BACKGROUND

Intellectual property assets such as patents are the core of many organizations and transactions related to technology. Licenses and assignments of intellectual property rights are common operations in the technology markets, as well as the use of these types of assets as loan security. Valuing patents is important for many purposes including determining business balance sheet values, taxes due, acceptable licensing rates, patent infringement damages, and capital allocations. Smith et al. identify intangible assets including patents as accounting for a majority of the value of many major business enterprises. The economic valuation of a patent based upon the cost, income, or market value theory is labor-intensive, costly, complex, and uncertain. Patent valuation requires an analysis to determine the meaning of the claims, a comparison of products to the meanings of the claims to determine what products are actually covered by the claims, a determination of the market covered by the claims of the patent, and a determination of the cost advantage of the patented technology compared to alternative technologies for that market. The cost advantage determination requires either knowledge of actual market costs or an actual or determination of a hypothetical patent licensing rate. For example, the valuation of the finance is the process of determining the present value of an asset (example: Patent). Valuations can be done on assets (for example, investments in marketable securities such as stocks, options, business enterprises, or intangible assets such as patents and trademarks) or on liabilities (e.g., bonds issued by a company). Valuations are needed for many reasons such as investment analysis, capital budgeting, merger and acquisition transactions, financial reporting, taxable events to determine the proper tax liability, and in litigation. Phenotyping from the plant is important factors that associate with patents. The genome is becoming the genotype by the environment the same as with the patent. It has to be construed that the patent economical relation environment is similar to a genotype and its environment. The genotype can be considered equivalent to an organization/ecosystem (patent) and phenotyping of the organization teaches that nature is a decentralized organization instead of the centralized structure of the organization.

The patent has a DNA like a genome and with the time. The IOT information exchange system and by the de-centralized environment of the patent the genotype was developed and through the phenotyping of the patent, differences in the valuation could be recognized as the result of the changing ecosystem during the live time of the patent. The entity is organized in a structure to use a smaller number of resources that are known as information technology (IT) as a communication protocol. The communication protocol that Consisting of the phenotyping of plants in conjunction with Clouding, the valuation factor is incorporated in the patent with concrete examples. Additionally, few existing patents for the different themes can be relied upon to prepare a Strategic Valuation Solution and perhaps some process systems and the IOT can also be relied upon for carrying out the present invention.

In addition, there is uncertainty associated with any patent analysis due to the risks that the patent claims may be found invalid and that the technology covered by the patent may lose its cost advantage due to development of alternative technologies. In addition, the data necessary for members of the public to perform the conventional economic valuation is simply not available to the public. This is because that data includes relationships between patents, product lines, and product line specific costs and earnings information, and companies rarely release that type of information and often do not even determine that type of information. Thus, the conventional valuation of patents is prohibitively expensive for many purposes, uncertain, and based upon data that often is unavailable to the public.

Further, for valuation of patents, there are various economic value constructs and valuation methods are available. In addition, there are also other standards available for valuation of patents, for example, the DIN-PAS 1070 and the IDW S 5. Typically, in the valuation method, the theory and practice are most common and significant methods chosen to the highest possible practical suitability and acceptance of the reports even before courts and to evaluate the valuation of the patent.

According to the license analogy, the above method is used for valuation and, if applicable, additionally the income value method may be employed for valuation of the patents. The income value method typically consists of the future incomes of the following years and the capitalization rate with the discounted earnings. The patent specific costs may have to be considered for valuation of the patents. In addition, production costs of the patent may be determined in accordance with and reported separately under the Accounting Law Modernization Act. The current value potential is issued at the valuation date. Future performance of patent may be discounted according to the credit cost for an average industry loan.

Therefore, there is a need for a fast, efficient, and objective means for valuing patents based on various dynamic parameters and substantially eliminate or at least partially address the aforementioned drawbacks in existing approaches used by the patent valuation practitioner to determine the valuation of the patent.

### SUMMARY

The present disclosure provides a method for semi-automated determination of a valuation of a patent application of an entity using machine learning based on a dynamic representation of the patent application in at least one dimension, characterized in that the method comprises:
generating a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
generating a representation of the patent application in at least one dimensions based on the at least one layer of information;
training a machine learning model by comparing the layer of the information for the patent application with corresponding layer of information for comparable patents;
processing a user input from a user interaction with the one-dimensional representation of the patent application;
providing the user input as training data to refine the machine learning model; and
dynamically updating a valuation of the patent application by applying a machine learning algorithm to the machine learning model.

It will be appreciated that the aforesaid present method is not merely a “method of doing a mental act”, but has a technical effect in that the method functions as a form of technical control using machine learning of a technical artificially intelligent system. The method involves building an artificially intelligent machine learning model and/or using the machine learning model to solve the technical problem of determination of a valuation of a patent application of an entity using machine learning based on a dynamic representation of the patent application in at least one dimension.

The present disclosure also provides a system comprising a server for determining a valuation of a patent application of an entity using machine learning based on a dynamic representation of the patent application in at least one dimension, comprising:

a processor; and

a memory configured to store program codes comprising:
a database generation module that generates a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
a representation generation module that generates a representation of the patent application in at least one dimension based on the at least one layer of information;
a patent comparison module that trains a machine learning model by comparing the layer of the information for the patent application with corresponding layer of information for comparable patents;
an user input processing module that processes a user input from a user interaction with the at least one dimensional representation of the patent application, wherein the user input processing module provides the user input as training data to refine the machine learning model, wherein the machine learning model is generated by the processor that is configured to
   generate a training information database with training information associated with evaluated patents, wherein the training information comprises at least one of external factors, historical data, current data, plan data or differential data associated with the evaluated patents;
   process an expert input from a valuation expert on the expert information of the evaluated patents, wherein the expert input comprises feedback associated with the expert information on the evaluated patents; and
   provide the training information and the expert input to the machine learning algorithm as training data to generate the machine learning model;
a patent valuation module that dynamically updates a valuation of the patent application by applying a machine learning algorithm to the machine learning model.

Embodiments of the present disclosure substantially eliminate or at least partially address the aforementioned drawbacks in existing approaches used by the patent valuation practitioner to determine the valuation of the patent.

Additional aspects, advantages, features and objects of the present disclosures are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system in accordance with an embodiment of the present disclosure;

FIG. 2 is a schematic illustration of a system comprising a processor that generates a machine learning model in accordance with an embodiment of the present disclosure;

FIG. 3 is a functional block diagram of a server in accordance with an embodiment of the present disclosure;

FIG. 4 is an exemplary view of a graphical user interface of a dynamic 3-dimensional image of a patent application in accordance with an embodiment of the present disclosure;

FIG. 5 is an exemplary view of a graphical user interface of valuation of a patent in accordance with an embodiment of the present disclosure;

FIG. 6 is an exemplary view of a graphical user interface of a dynamic representation of a ranking of a patent in at least one dimension in accordance with an embodiment of the present disclosure;

FIG. 7 is an exemplary view of a graphical user interface of a dynamic representation of a litigation probability of a patent in at least one dimension in accordance with an embodiment of the present disclosure;

FIG. 8 is an exemplary view of a graphical user interface of a dynamic representation of litigation probability of a patent application to be evaluated in at least one dimension in accordance with an embodiment of the present disclosure;

FIG. 9 is an exemplary view of a graphical user interface of a dynamic representation of an examiner analysis of a patent to be evaluated in at least one dimension in accordance with an embodiment of the present disclosure;

FIG. 10 is an exemplary view of a graphical user interface of a dynamic representation of a valuation of a patent family of a patent application to be evaluated in at least one dimension in accordance with an embodiment of the present disclosure;

FIGS. 11A-11C are block diagrams illustrating a process of a user interaction with a system in accordance with an embodiment of the present disclosure; and

FIGS. 12A-12C are flow diagrams illustrating a method for semi-automated determination of a valuation of a patent application of an entity using machine learning based on a dynamic representation of the patent application in at least one dimension in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides a method for semi-automated determination of a valuation of a patent application of an entity using machine learning based on a dynamic representation of the patent application in at least one dimension, characterized in that the method comprises:
generating a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
generating a representation of the patent application in at least one dimension based on the at least one layer of information;
training a machine learning model by comparing the one layer of the information for the patent application with corresponding one layer of information for comparable patents;
processing a user input from a user interaction with the at least one dimensional representation of the patent application;
providing the user input as training data to refine the machine learning model; and
dynamically updating a valuation of the patent application by applying a machine learning algorithm to the machine learning model.

The present method thus helps to provide a holistic strategic valuation for the patent application in at least one dimension using the at least one layer of information. The present method helps to provide a sustainable economic valuation for the patent application considering economic, social and ecological factors associated with the entity or the patent application. The valuation of the patent application is mainly used for investment analysis, capital budgeting, merger and acquisition transactions, financial reporting, taxable events to determine the proper tax liability, and litigation.

The present method also helps to forecast the valuation of the patent application as the valuation of the patent application increases by the lifetime and a country of the patent and a market-based calculated license of the market revenue volume in that field of industry sector. The present method thus updates the valuation of the patent application dynamically when there is a change in the at least one layer of information.

In an embodiment, the at least one dimension optionally associated with megatrends, indicator and key figures.

In an embodiment, the megatrends are drivers of change. The megatrends are the classic indicators of change and that drive future markets. The impact of the megatrends creates new growth areas and potential for value creation. The megatrend is not a short-term trend, but rather a trend with longevity. The megatrend may be determined by collecting and analysing a huge amount of historical data.

In an embodiment, the megatrends optionally be determined by analysing the Intellectual property information, the market information, the finance information, the company information, the people information, the time information and the geographic information.

In an embodiment, the megatrend optionally be determined by analyzing at least one of demographic changes, societal disparities, differentiated lifeworlds, digital transformation, biotechnical transformation, volatile economy, business ecosystems, anthropogenic environmental damage, changed work environments, new political world order, global power shifts, or urbanisation.

In an embodiment, the demographic change optionally be determined by analysing regional development asymmetries, global population ageing, urban growth regions and increasing migration waves. In an embodiment, the information associated with the regional development asymmetries, the global population ageing, the urban growth regions and the increasing migration waves is obtained by analysing the information associated with the megatrends. The information associated with the megatrends is maintained by a future institution, a local or government institution and/or a non-government organisation. In an exemplary scenario, in future, the global population may have grown by another billion to 8.5 billion people. The population growth is regionally asymmetrical. For example, the birth rate in Africa is far exceeds the population replacement level. Almost half of the world's population growth between now and the future may take place in Africa. The population of Europe, by contrast, is shrinking. On the other hand, with the exception of Africa, most regions throughout the world are affected by population ageing. One of the main developments concomitant with the population explosion is the expansion of urban living space. The speed and extent of urbanisation in many Asian and African states is unprecedented. Burgeoning migration waves throughout the world are also contributing to increasing urban sprawl.

In an embodiment, the social disparities are optionally determined by analysing increasing precarious living conditions, increasing wealth concentration, intensification of social conflicts, and/or increasing rural-urban disparity. Whilst inequalities between states are diminishing at the global level, they are increasing within specific regions and countries. For example, the expected future economic growth in Europe, North America and China may almost exclusively benefit the more affluent sectors of these societies. More and more families are facing poverty, social exclusion and material deprivation. This is particular true of rural areas that are in danger of being completely cut off from the rapid developments in urban centres. The interactions between different aspects of inequality lead to a significant potential for social conflict which encourages expression in political radicalisation, terrorist actions and politically motivated violence.

In an embodiment, the differentiated life world is optionally determined by analysing weakening of traditional gender roles, new forms of individuality, dynamic biographic developments, complex identity formation, global patterns of consumption and/or sophisticated consumption. The divergence between people's individual life worlds optionally increases in future. The gender roles may no longer be accepted as being predetermined, and may increasingly be defined by individuals themselves. The new forms of individuality may be established based on complex identity formation processes and modified body images. The linear biographies optionally morph into complex or dynamic multi-graphs. The patterns of consumption, which are motivated by multiple factors such as increasing demand for personalised products, a deeper integration of customers in product development processes, increasing sensitisation to sustainable consumption and/or a transition from ownership to sharing platforms in certain product categories, may also become increasingly differentiated.

In an embodiment, the digital transformation is optionally determined by analysing digital networking in everyday life, new opportunities through big data, establishment of IoT paradigms, breakthroughs in the fields of artificial intelligence and robotics and vulnerability of critical infrastructure. The digital technologies continue to dominate all areas of life, whereby the dynamics of change may continue to increase in future. Driven by ever faster data connectivity, the miniaturisation of sensors and processors as well as devices that are intuitive to operate and offer new application functionality, networking of objects are penetrated into every corner of daily life. Within the emerging “internet of things” (IoT), physical objects may communicate and interact with their surroundings. The developments in the field of artificial intelligence have made it possible to analyse enormous amounts of data in real time thus enabling powerful solutions based on automation. Robots and machines may discover optimised solutions to complex problems without the need for human intervention. However, internetworking involves a certain amount of risk. The cybercriminals are increasingly training their sights on critical infrastructure.

In an embodiment, the biotechnical transformation is optionally determined by analysing development of modified and synthetic organisms, improvement of human abilities, smart materials and new construction principles and existential risks. The future may heavily influence by developments in biotechnology and nanotechnology, the neuro and materials sciences and medical engineering. An increasing profound understanding of the laws of life enables man to intervene creatively in natural process, in general, and in the development of biological organisms, in particular, both at the atomic and sub-atomic levels, but also at the scale of networked macro systems. This is altering the understanding of life in profound ways. The bio-technical transformation involves a number of concomitant risks, by artificially intervening at all levels of the system with increasing frequency and mankind which is entering terra incognita.

In an embodiment, the volatile economy is optionally determined by analysing global debt overload, concentration of productivity and profits, erratic economic and trade policy, disruptive change in industry structures and/or short-term investment patterns. The companies and economies experience increasingly volatile development dynamics. Several factors are contributing to this development. On one hand, mutual global dependencies have increased at the same pace as the flows of international capital and goods have burgeoned in the wake of globalisation. The risk of contamination in times of crises has also increased and local events may include global consequences. In addition, the incidence rate of crises of an international character is also increasing, which deprives national economies of the ability ever to achieve full recovery. Increasingly, a reliable monetary, economic and fiscal policy are becoming a thing of the past. Industry structures are changing under the influence of disruptive innovations. Further, speculative investment activities are also destabilizing the global economic system.

In an embodiment, the business ecosystems are optionally determined by analysing new interface markets, expansion of the platform economy, sharing as a business model, flexibilization of production systems and/or shared values as a new paradigm. Businesses are increasingly being confronted with dynamically changing commercial environments. The technical transition is accompanied by cross-sectoral innovations at the business model and organisational process levels. Innovations arise at the interfaces of formerly separate sectors, whose boundaries are becoming increasingly not coherent as a result of integrated products and services. Cross-sectoral value creation networks and structures are emerged as exemplified by the platform economy or collaborative business operations. Highly flexible production processes and integrated corporate structures are created for innovations. Business objectives are also changed and are increasingly extended to include positive external effects on the environment and society as a whole.

In an embodiment, the anthropogenic environmental damage is optionally determined by analysing anthropogenic climate change, increasing environmental pollution, loss of biodiversity, increasing volumes of waste products and tightening of regulations relating to the environment. The environment suffers from the subsequent costs of the human lifestyle. No trend reversal has yet been achieved in greenhouse gas emissions. The main emitters are power stations, industrial plant, traffic systems and agriculture. Surface and water temperatures are increased as a result of anthropogenic climate change, in addition to which the polar caps are started to melt, sea level is rising and extreme weather events are becoming more frequent. Noise and light pollution are also increased steadily, whilst rubbish piles are grown and soils are contaminated. At the same time, a flood of laws, regulations and initiatives are attempted to prevent human beings from destroying the basis of their own continued existence.

In an embodiment, the changed work environments are optionally determined by analysing decentralised organisation, assisted and automated working, more complex tasks, dynamic skills development and/or increasing diversity. A fundamental change is recognisably taking place in the work environment at levels. Work is organised on a more flexible basis, both spatially and chronologically, and companies are attempted to dissolve traditional silos in favour of more open structures. Workers are enjoying the support of digital assistant systems, exoskeletons are reducing the strain of physical tasks, artificial Intelligence and robotics are giving rise to new forms of collaboration and automation. The time contingencies for more complex human activities may increase in future, but workers may be expected to accept more personal responsibility and self-organisation. In addition, they may be required to work continuously on the ongoing development of their personal skills profiles. At the same time, workforces may be diversified, which presents new challenges for both managers and staff.

In an embodiment, the new political world order is optionally determined by analysing multipolar world, asymmetrical conflict lines, authoritarian varieties of democracy, dismantling of welfare provision and/or regional integration projects. For example, the political world order is currently undergone a transition towards multi-polarity and the unilateral “pax” americana is disintegrated. The geopolitical situation is currently dominated by volatility, instability and asymmetric conflicts. The influence of major emerging economies such as India and especially China, but also smaller states, regional powers and non-state actors, is increased, resulting in new distribution struggles for power and resources. A new system contest is on the horizon between liberal market economic democracies on the one side and authoritarian state controlled capitalist systems on the other. At the same time, calls for a strong, even authoritarian state is being countered by the slow but steady withdrawal of state-funded social safety nets on the part of many states.

In an embodiment, the global power shifts are optionally determined by analysing emergence of new powers, growth of the global middle class, the increasing influence of non-state actors, shift from states to municipalities and women on the rise. The present time is dominated by power shifts at different levels, initially between states and regions, mostly in a west to east direction. For example, the resurrection of Asia in its former glory. Global welfare may also be subjected to a decentralising distribution. A global middle class may emerge, albeit characterised by strong regional variations. Ultimately, the training-intensive requirements of the knowledge and information society may be conducive to a progressive power transfer from men to women.

In an embodiment, the urbanisation is optionally determined by analysing unmanaged urban growth, modernisation crisis in municipal infrastructures, expansion of adaptive infrastructure systems and/or generative and sustainable urban development. The proportion of the world's population living in cities may increase from the current 54% to 60% in future. In emerging and developing economies, in particular, rapid urbanisation is often unmanaged resulting in burgeoning urban sprawl. Meanwhile, western cities face the challenge of renovating their ageing, sometimes crumbling, infrastructures, a task whose accomplishment may function as an acid test for many towns and cities. The importance of adaptive infrastructural systems, designed to react to dynamically changing challenges and requirements, are increased in the context of urban infrastructure expansion as they are digital infrastructures and are designed to increase the efficiency and public accessibility of urban systems. In an embodiment, the patent value indicators optionally comprise the intellectual property information.

In an embodiment, the patent value indicators may optionally comprise community application, R&D strength of the invention, R&D applicant ratio, technology in different term trend, sustainability of technology trend, a total size of activity, a family size, transferability to different industries, heterogeneity of potential applications, exploitation in different technologies (within a certain industry), a total amount of exploitation possibilities, an evidence of use, relevance for other technologies/applications, differentiation to the state of the art, differentiation from direct competitor-technologies, interfering with competitors technologies, validity level, patent maturity, claim width and coverage, validity in certain countries, intended worldwide protection, and procedural state.

In an embodiment, the community applications are determined based on the number of different applicants in the patent application. The community patent applications make a usability of the patent application more difficult due to multiple assignees, and the coverage of the claims is smaller as the assignees have their own usage and further own inventions. In an exemplary scenario, if the community patent is traded, it means having multiple assignees with multiple interests sitting at the table.

In an embodiment, the R&D strength of the invention is determined based on an number of inventors mentioned in the patent/application.

In an embodiment, the research and development applicant ratio are a company specific indicator, taking into account if this is a technological driven company or not. The total amounts of patents are compared with the employees of a company to determine how important patents are for a certain industry. If the R&D ratio higher means, it indicates that the more important patents are within the sector.

In an embodiment, the technology in different term trend is determined by comparing common activity within an (IPC) International Patent Classification to a reference period. If the activity is higher when compared with the earlier period, it indicates that the technology is trending technology. The short and medium term comparison are based on different reference periods.

In some embodiments, the sustainable technology trend is determined by comparing different reference periods. If a technology field is a very short trend or if the trend is sustainable is determined by comparing different reference periods.

In some embodiments, the total size of activity is total activity per time period. The total size of activity is determined by counting the total amount of inventions that were made within a certain period in this technology field.

In some embodiments, the family size of the patent application is the number of equivalent patents that are related to the same invention and coverage of economies with IP-protection related to the same invention. The equivalent patents may optionally comprise divisional and continuation patents. Also, the relevance of a certain technology for a certain market are also considered for determining family size of the patent applications.

In some embodiments, the transferability to different industries indicate the usability of the invention for different branches. In an example, the invention may be applied to consumer goods as well as in handling machines. The transferability to different industries is determined based on the amount different IPC sectors that are mentioned within the patent.

In some embodiments, the heterogeneity of potential patent applications is determined using different IPC analysis algorithm. For a certain technology field, the questions may be similar, and for the different technology fields, the question may be thinkable within a field.

In some embodiments, the exploitation in different technologies within a certain industry is identified using a third different algorithm on the IPC classes. The exploitation in different technologies provides information on how the different addressed applications may be. The three IPC indicators taking different depths into account are a general industry independency, a technology independency and an application independency.

In an embodiment, the total amount of exploitation possibilities is determined by measuring the total amount of different industries, technologies, patent applications but not heterogeneity.

In an embodiment, for the evidence of use indicator, an important value indicator if an infringement may be detected. If the important value indicator is identified, there is less potential for a patent. For process patents, the infringement may be difficult to prove.

In an embodiment, the relevance for other technologies/applications is determined based on how many other patents of foreign assignees refer to the given patent, taking the patent age into account. For example, if the patent covers broader claims, the more often other patent attorneys may refer to the patent in order to differentiate.

In an embodiment, the differentiation to the state of the art is identified citations made by the patent office that indicates the differentiation of state of the art in general. For example, “is patent really new” is an essential question for patent valuation.

In an embodiment, the differentiation from direct competitor-technologies analysed based on the oppositions performed by different competitor. The oppositions for the patent application are performed by different competitor companies during the opposition phase results the direct relevance for others in terms of utilisation. This represents that a technology is close to the state of the art but directly in relation to a competitor.

In an embodiment, the interfering with competitors technologies are analysed based on the oppositions. The oppositions are also documented that there may be a direct utilisation option either by selling or by licensing. This particular patent may cause problem to a user as long as it is of general relevance, documented through cited-bys, and the value is high.

In an embodiment, the validity level is determined based on the oppositions ratio to cited references by patent office examiners. For example, the value of the patent application is high when the patent application is infringed by a user or a company and it is far from the state of the art in general.

In an embodiment, the patent maturity indicates a remaining time for exploiting the given patent into account. A young application may have a maximum remaining term of utilisation but it may be not granted. The value is maximum according to this starts after opposition phase and decreases afterwards. Within the final half a year before a patent ceases, it is practically not tradeable anymore according to the remaining term of utilisation, the value decreases drastically in its final stage of lifetime.

In an embodiment, the claim width and coverage are determined based on the number of claims and the number of the independent claims. The claims are essential for the legal coverage of a patent. The independent claims are more important that the total claims of the patent application. The independent claims potentially cover and block the effect of a patent. The patent application is split into more than one application when the invention includes different procedures and products.

In an embodiment, for a validity of the given patent in certain countries, for example European countries, it counts the amount and economies of the currently covered contracting states, where the patent fees are maintained. For single countries, the economical size of the country that the patent is filed in is taken into account. Whenever a patent protection is not kept, it indicates that a technology has lost importance in a certain market, either the market shrinks or the general relevance of a technology decreases and both has a negative impact on a patent value.

In an embodiment, the intended worldwide protection is identified based on the patent family of the patent application. For example, if the international applications in the patent family, the patent application is planned for a worldwide protection. The market for inventions that filed as an international application is global.

In an embodiment, the procedural state of the patent application optionally comprises three stages in a patent life time namely application, granted, expired. There is no value is assigned on Expired patents. The value of applications is much lower compared to when it is granted. This lower value takes the uncertainty of getting granted into account. The time that taken by the application to grant and countries that grants the application fast are accounted for a grant.

In an embodiment, the key figures or quality figures may optionally comprise an assignee score, a market coverage score, a market attractiveness score, a technical quality, and/or a legal score.

In an embodiment, the assignee score is determined based on the type of the assignee of the patent application. The assignee has the strong influence on the patent application value.

In an embodiment, the market coverage score indicates the amount of a market size that is potentially addressable with the invented technology/formulation with a legal intellectual property protection, which also includes a freedom to operate and the economy size.

In an embodiment, the market attractiveness score is determined based on the trend and total technical activity. The market attractiveness score reflects if the technology/formulation follows a trend. If a patent has more competition, the more potential licensees, the more potential buyers for a patent, the bigger the market is in general.

In an embodiment, the technical quality is determined based on the technical coverage, the detectability of infringement, the differentiation to state of the art, the technical relevance etc. The technical quality on a company level shows the degree of innovation that can be derived from a company's IP.

In an embodiment, the legal score is determined based on the legal aspects such as the procedural state, the age or claims related aspects. For example, on a company level, the legal score is a legal strength of IP in terms of its degree of protecting effect.

The present method involves building an artificially intelligent machine learning model and/or using the machine learning model to solve the technical problem of determining a valuation of a patent application of an entity using machine learning based on a dynamic representation of the patent application in at least one dimension.

In an embodiment, the machine learning model optimizes a data processing using the training information and the expert input as the training data. The training information comprises a structured and unstructured historical and present data pertaining to a domain such as legal, patent, industry, market, commercial information and regulations, use-case specific requirements and expectations, and the like. In one example embodiment, the historical data comprises predicated future data pertaining to the domain. The expert input comprises a structured and unstructured knowledge related and regulation related data pertaining to the domain which is maintained by the expert. The expert pertains to the domain to which the structured and the unstructured data belong. The expert controls and structures the machine learning model using the training information and the expert input to predict the future data to solve the technical problem of determining a valuation of a patent application of an entity.

In an embodiment, the historical data comprises a data related to a past action in the domain such as legal, patent, industry, market, commercial information and regulations, use-case specific requirements and expectations, and the like. The machine learning model analyses the present data with the historical data to recognise a pattern in the past and matches them with similar situations, model, paternities in the present and future, which is not limited for market, legal, business, economical and patent information from any information resources, to predict future data to determine a valuation of a patent application of an entity.

According to an embodiment, the entity comprises any one of an individual, a start-up company or a medium or a large-scale company.

In an embodiment, the intellectual property information optionally comprises at least one of infringement discoverability, availability of established market, life expectancy in the market, availability of mapping to an intangible asset, licensing potential, licensed intangible assets or market growth, wherein the market information of the entity comprises at least one of technology trends or industry trends. The finance information comprises at least one of assets cash flow, remaining time and money left to invest, risk-free internet rate, royalty rates, investments and maintenance costs, historical licensing data, detailed technology or market analysis.

In an embodiment, the company information optionally comprises people, entity, balance, financial situation, stakeholder, business environment, Intellectual property value cost, income, intellectual property rank, intellectual property market, licensing, product, sector, competitor, the market share of product or target market.

In an embodiment, the patent valuation is optionally associated with legal status and industrial property family, application pending, granted, prospect of grant, in force, fees paid, test reports answered, objections of third parties, already procedures survived, rights to the invention, applicant, if applicable, current patent owner, inventor, legal relationships according to employee invention right, basic protection right or dependent property right, identifiable or assigned rights of third parties to the patent rights of use, rights of disposal, licensing, state of the art and scope of protection, possibly a statement by a patent attorney.

In an embodiment, the patent valuation is optionally associated with the company data, competencies of the company, means of production, approval, certification, industry-specific standards, product portfolio, strategy market access, customers, sales, networks economic data turnover, share of sales of enterprises, R&D share, employees intention to use, in-house feasibility vs. licensing or property rights sale share of intellectual property rights in product/process, investment requirements, fixed costs, production costs, economies of scale, and/or existing resources.

In an embodiment, the people information optionally comprises at least one of a people network or communication between the people of the entity. The time information of the entity optionally comprises at least one of past information, present information or future information. The geographic information of the entity optionally comprises a location of the entity.

In an embodiment, the patent valuation is optionally determined based on the company law events, transfer-oriented events, conflict-based or legal causes, financing and accounting-related events, and/or management-oriented events (For example: Research and development, technology, innovation management).

In an embodiment, the company law events optionally comprise but not limited to a company purchase event, a sale and merger event, a participation event (e.g. due diligence), an IPO event, and/or a Joint venture. The transfer-oriented events may optionally comprise but not limited to a patent buying and selling event, a licensing and awarding event, a technology transfer event, and a cross licensing event.

In an embodiment, the conflict-based or legal causes optionally comprise but not limited to liquidation, insolvency, damage assessment, employee invention compensation, and transfer prices.

In an embodiment, the financing and accounting-related events may optionally comprise but not limited to equity financing, debt financing, mortgage, founding, and accounting.

In an embodiment, the management-oriented events (R&D, technology, innovation management) may optionally comprise but not limited to patent and application strategy, risk analysis, profitability analysis, and value-based management.

In an embodiment, the patent valuation is optionally associated with the market segmentation, application area, industry including sales, competitors, competing products economy technical and economic advantages, product benefits, customer benefits, substitutability trends, technology/product life cycles target group for the applications market volume, market potential, sales expectations, achievable price (if necessary to be determined by expert interviews), and/or market entry barriers.

In an embodiment, the patent valuation is optionally associated with the possible applications, scalability possible products and procedures, new product or improvement technical feasibility/scientific accuracy, status of implementation evidence, series of measurements, prototype, practicability, authorization restrictions and procedures technology environment, alternative solutions, workarounds (financial, technical effort, if necessary, traceability of property right infringement), investment requirements, fixed costs, production costs, economies of scale, and/or existing resources.

The present invention optionally generates a representation of the patent application in one or two dimensions the one or more layers of the information.

In an embodiment, individual external information from the at least one layer of the information optionally impacts the valuation result in order to obtain the at least one dimensional representation, which is similar to a process of phenotyping a plant not only according to its yield values, but also its intangible values are measured. In an embodiment, the phenotyping is the analyses of a phenom, a seat in the beginning that is influenced by water, fertilizer, sun, air pollution, light, and other plants around ground material. The plant is having an individual growth experience and the plant itself is growing with its value regarding the environment. The patent valuation is similar to the Phenotyping of a plant. The phenotyping of a patent application comprises measuring a several layers of patent environment such as the megatrends, indicators, key figures and the like. The extension of this present method to the entity generates a complete representation of a patent portfolio of the entity in at least one dimension.

According to an embodiment, the representation of the patent application is generated in at least one dimension using at least one of an analogue tool, a 2-dimensional tool, a 3-dimensional tool, a virtual reality tool, or an augmented reality tool.

According to an embodiment, the at least one layer of information is obtained from a plurality of information resources by performing
connecting a plurality of physical units of IoT devices with the plurality of information resources for collecting the at least one layer of information;
recording the at least one layer of information from the plurality of information resources; and
processing the at least one layer of information to generate the database.

The plurality of physical units of IoT devices comprises at least one of inter-networking of physical devices, vehicles (also referred to as “connected devices” and “smart devices”), and buildings. In addition to the Internet of Things devices, cyber-physical systems optionally communicate and cooperate with each other and with humans in real time, and via the Internet of Services, both internal and cross-organizational services are offered and used by participants of the value chain.

In an example embodiment, for collecting the public data in streets, public areas and people in countries such as China, in the US, there is a patent application of wifi and device networking in the area of early warning regarding emergencies. With the access and the collection of public data, the patent application includes more potential and more value. The databases obtain information from different kind of resources such as user or other databases comprising imported information. The amount of information is increased by the collecting data from sensors in chip cards, wearables, mobile systems user profiles. When the information is collected from different databases, the information is more and is used for data analytics to receive better results of reports including valuation of the patent application. The IOT devices collect information—by fast ways without high memories based new technologies. Therefore, large data can be collected, stored and analysed using the IOT devices.

In an embodiment, the augmented reality, virtual reality and bionic lenses are tools to represent the results of the analytics and valuation of the patent application. Besides, a classical or smart transparent screen are available screens for individual observation of data represented in the field of view of people to receive information.

In an embodiment, the people are working permanently or partly with smart glasses or bionic lenses. The information presented in that sample project of a transaction and the person like to receive the IP valuation information in detail on its individual own screen.

In an embodiment, the bionic contact lenses are devices that provides a virtual display for variety of uses from assisting the visually impaired to video gaming. The device may have a form of a conventional contact lens with added bionics technology in the form of augmented reality with functional electronic circuits and infrared lights to create a virtual display allowing the viewer to see a computer-generated display that is superimposed on the outside. The bionic contact lenses enable the user to view the information or read text, numbers, figures and images projected and merged in augmented way with the environment and surrounding. The smart glasses provide more memory and data volume to collect the information or read text, numbers, figures and images projected and merged in augmented way with the environment and surrounding. In an embodiment, connected devices and smart devices of the smart glass and the bionic lenses provide data that needs for the valuation of the patent.

In an embodiment, the patent valuation method is saved on a hardware device and in a particular time window and processed again for further analyses after a particular time (i.e. time frames like a part of a second until some hours) repeating that method until the analyses have reached a particular level of result to be presented in any screen or a VR, AR bionic device.

In an embodiment, dashboards are structured top down with the information to receive more and more detailed if the recipient goes down in the lower level of information grade.

In an embodiment, the IOT devices are structured in more mashing technology to transfer data from one device to other using smaller amount of computer memories storages so the information is faster in the exchange between the logs. Zig bee technology transfers faster data between and within the network. The information needs to collect is less and the data analyst may be faster with the result of a faster data exchange rate.

According to an embodiment, the plurality of physical units of the IoT devices are embedded with at least one of electronics, software, actuators or network connectivity tools of the entity, wherein the plurality of physical units collects and communicates the at least one layer of information, wherein the plurality of physical units of the IoT devices are sensed or controlled remotely using the distributed network. In an embodiment, when IOT devices are augmented with sensors and actuators, the IOT devices acts as cyber-physical systems, which also encompasses technologies such as smart grids, virtual power plants, smart homes, intelligent transportation and smart cities for collecting the layers of the information from the plurality of information resources. Each information is uniquely identified by cyber-physical systems and interoperated within the existing Internet infrastructure.

According to another embodiment, the machine learning model is generated by
generating a training information database with training information associated with evaluated patents, wherein the training information comprises at least one of external factors, historical data, current data, plan data or differential data associated with the evaluated patents;
processing an expert input from a valuation expert on the expert information of the evaluated patents, wherein the expert input comprises feedback associated with the expert information on the evaluated patents; and
providing the training information and the expert input to the machine learning algorithm as training data to generate the machine learning model.

In an embodiment, the expert input may be provided using an expert device.

In an embodiment, the patent valuation method uses process-oriented knowledge management that deals with pragmatic, domain-specific ontologies from existing process models and documents derived. For process-oriented knowledge management, important for an ontology is the processing of, for example, the terms used in the patent application and their relation to wider circles (technology, industry, science, land, megatrend). Technical tools for the extraction of, for example, technical terms, indicators, activity figures are special databases or text mining methods. Linguistic-statistical text analysis tools are used with these tools and can be used, for example Patent relevant documents, key terms and some semantic relationships of these terms identify each other (statistical collocation analysis) via an interface to the semantics, and these can be integrated directly into the process models and ontologies. The result of the modelling (process, organization, function, information and resource models) is stored in a semantic language and is then available as a library.

The representation of a process in a tree diagram facilitates the mediation of a procedure in the execution of a task, as in a previous case of the task of a patent search, which models practical knowledge, primarily process knowledge. This model now has to be implemented in terms of software, so that often recurring knowledge-intensive tasks may be routinely processed along reproduced business processes.

In an embodiment, terms familiar to the company and their relation to broader circles (e.g. industry, science, country, world) are processed in corporate ontology. Technical aids for extracting technical terms comprises special databases or text mining methods. In some embodiments, a linguistic-statistical text analysis tool is used for extracting technical terms. With this tool, important core terms and some semantic relationships between these terms may be identified from company-internal documents using statistical collocation analysis. The identified terms are integrated directly into the process models and the ontologies via an interface. The result of the modelling (e.g. process, organizational, functional, information and resource models) is stored in the semantic web language (OWL) and is then available as a library. The external glossaries may be stored in the semantic web language (OWL) (e.g. Business objects from SAP R/3 ASAP Toolkit).

In an embodiment, the machine learning model for determining the patent valuation is data driven pattern tree models. For example, the pattern trees are induced in a top-down instead of a bottom-up manner which leads to the improved performance. The aforementioned pattern trees models address the problem of classification. The proposed variant of the top-down method is suitable for solving regression problems, i.e., problems with a real-valued target variable.

In an embodiment, the machine learning model is fuzzy pattern tree. The fuzzy pattern tree is a machine learning model for classification and may approximate real-valued functions in an accurate manner. The fuzzy pattern tree is a hierarchical, tree-like structure, whose inner nodes are marked with generalized (fuzzy) logical and arithmetic operators, and whose leaf nodes are associated with fuzzy predicates on input attributes. A pattern tree propagates information from the bottom to the top. A node takes the values of its descendants as input, and combines them using the respective operator, and submits the output to its predecessor. Thus, the pattern tree implements a recursive mapping producing outputs in the unit interval.

The top-down algorithm for learning pattern trees for regression, PT-regression, implements a beam search in the space of pattern trees, by maintaining the B best models so far (for example, B=5 is used as a default value). The basic steps of the approach are as follows: (i) initialize with primitive pattern trees, (ii) Iter candidates by evaluation of their performance on the training data, (iii) check stopping criterion, (iv) generate new candidates through local search and (v) repeat at step (ii).

The machine learning model starts by computing the set of all primitive pattern trees P, namely pattern trees consisting of only a single root node, labelled by a fuzzy set Fᵢⱼ. Additionally, the first candidate set, C°, is initialized by the D best basic pattern trees, i.e.

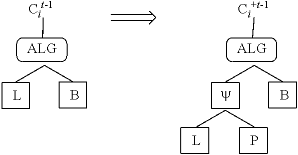

In top to down induction, a leaf node is expanded through replacement by a basic tree.

In an embodiment, the candidates are selected and passed to the next iteration, unless the termination criterion is fulfilled.

To make pattern tree learning amenable to numeric attributes, these attributes have to be “fuzzified” and discretized beforehand. Fuzzification is required because fuzzy logical operators at the inner nodes of the tree expect values between 0 and 1 as input, while discretization is needed to limit the number of candidate trees in each iteration of the machine learning model. Besides, fuzzification may also support the interpretability of the model.

Fuzzy partitions can of course be defined in various ways. In one implementation, a domain is discretized in a generic way, using three fuzzy sets Fi,1, Fi,2, Fi,3 associated, respectively, with the terms “low”, medium” and “high”. The first and the third fuzzy set are defined as

$${F}_{i , 1} ( x ) = \{ \begin{matrix}1 & x < min \\ 0 & x > max \\ 1 - \frac{x - min}{max - min} & otherwise\end{matrix} , \\ {F}_{i , 3} ( x ) = \{ \begin{matrix}1 & x > max \\ 0 & x < min \\ \frac{x - min}{max - min} & otherwise\end{matrix} ,$$

To evaluate the performance of a pattern tree, the squared error loss is computed which produces on the training data

[symbol]

={(x⁽ⁱ⁾,y⁽ⁱ⁾)}ᵢ₌₁ⁿ⊂ [symbol] ×[0,1].

Thus, with f(●) denoting the function implemented by the tree, an equation is derived as follows:

$$L ( f ) = \frac{1}{n} {\sum }_{i = 1}^{n} {( f ( {x}^{( i )} ) - {y}^{( i )} )}^{2} .$$

In an embodiment, a disadvantage of the squared error loss, i.e. sensitivity toward outliers, is less problematic in the proposed method. The output values are bounded by 0 and 1, and the same holds true for the squared loss. In combination with a transformation like (2), which is needed to handle output variables with unbounded range, the approach can thus be seen as a kind of robust regression technique. Indeed, the combination of (2) and (4) produces an effect quite comparable to Huber's loss function, which combines the absolute (L₁) error for large differences with the squared error (L₂) for small ones.

The termination decision is based on the relative improvement of the best model in the (t+l)-st iteration (i.e., the model with the lowest loss (4)) as compared to the t-th iteration. More specifically, the algorithm stops if

Lₘᵢₙ^{t+1}>(1−€)Lₘᵢₙ^{t},

i.e., if the relative improvement is smaller than €, where € € (0,1) is a user-defined parameter. Based on empirical evidence, the method proposes €=0.001 as a suitable value for this parameter.

In an embodiment, with min and max being the minimum and the maximum value of the attribute in the training data. All operators appearing at inner nodes of a pattern tree are monotone increasing in their arguments, and it is clear that these fuzzy sets can capture two types of influence of an attribute on the output variable, namely a positive and a negative one.

The fuzzy set Fi,2 is meant to capture non-monotone dependencies. It is defined as a triangular fuzzy set with center c as follows:

$${F}_{i , 2} ( x ) = \begin{matrix}0 & x < min \\ \frac{x - min}{c - min} & min < x < c \\ \text{?} & c < x < max \\ 0 & x > max\end{matrix}$$

$$\text{?} \text{indicates text missing or illegible when filed}$$

The parameter c is determined so as to maximize the absolute (i.e. pearson) correlation between the membership degrees of the attribute values in Fi,2 and the corresponding output variable on the training data. In case the correlation is negative, Fi,2 is replaced by its negation 1−Fi,2.

Finally, nominal attributes are modelled as degenerate fuzzy sets, for each value v of the attribute, a fuzzy set with membership function is introduced.

$${Term}_{v} ( x ) = \{ \begin{matrix}1 & x = v \\ 0 & otherwise\end{matrix}$$

The present disclosure provides a system comprising a server for determining a valuation of a patent application of an entity using machine learning based on a dynamic representation of the patent application in at least one dimension, comprising:

a processor; and

a memory configured to store program codes comprising:
a database generation module that generates a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
a representation generation module that generates a representation of the patent application in at least one dimension based on the at least one layer of information;
a patent comparison module that trains a machine learning model by comparing the one layer of the information for the patent application with corresponding one layer of information for comparable patents;
a user input processing module that processes a user input from a user interaction with the at least one dimensional representation of the patent application, wherein the user input processing module provides the user input as training data to refine the machine learning model, wherein machine learning model is generated by the processor that is configured to
   generate a training information database with training information associated with evaluated patents, wherein the training information comprises at least one of external factors, historical data, current data, plan data or differential data associated with the evaluated patents;
   process an expert input from a valuation expert on the expert information of the evaluated patents, wherein the expert input comprises feedback associated with the expert information on the evaluated patents; and
   provide the training information and the expert input to the machine learning algorithm as training data to generate the machine learning model;
a patent valuation module that dynamically updates a valuation of the patent application by applying a machine learning algorithm to the machine learning model.

According to an embodiment, characterized in that the processor further configured to process information associated with at least one of megatrends, indicators or key figures to predict the future data to determine a valuation of a patent application of an entity.

The advantages of the present system are thus identical to those disclosed above in connection with the present method and the embodiments listed above in connection with the method apply mutatis mutandis to the system.

The communication network may be a wired network or a wireless network. The server may be a tablet, a desktop, a personal computer or an electronic notebook. In an embodiment, the server may be a cloud service.

The server optionally partially comprises the above modules to determine a valuation of a patent application of an entity using machine learning based on a dynamic representation of the patent application in at least one dimension. The system may comprise more than one server that may comprise one or more of the above modules. In an embodiment, the server comprises a second processor for generating the machine learning model. In an embodiment, the second processor may execute the one or more of the above modules. In another embodiment, the second processor is executed in an external server. The server may comprise a server database that stores the machine learning model.

According to another embodiment, the system comprises a user device, communicatively connected to the server, for providing a user input by interacting with the at least one dimensional representation of the patent application. In an embodiment, the server provides the at least one dimensional representation of the patent application on the user device for enabling the user interaction with the at least one dimensional representation of the patent application.

According to yet another embodiment, the system comprises an expert device, communicatively connected to the server, for providing an expert input from a valuation expert on the evaluated patents. The expert input comprises a feedback associated with the expert information on the evaluated patents. The expert device optionally comprises a user interface that enables the valuation expert to provide the expert input and the expert input is used as training data to generate the machine learning model. According to another embodiment, the processor obtains the at least one layer of information from a plurality of information resources by performing
connecting a plurality of physical units of IoT devices with the plurality of information resources for collecting the at least one layer of information;
recording the at least one layer of information from the plurality of information resources; and
processing the at least one layer of information to generate the database.

The IOT devices are communicatively connected to the plurality of information resources for collecting the layers of the information. The IOT devices are communicatively connected with the server for providing the collected information for patent valuation.

According to yet another embodiment, the processor is configured to generate the representation of the patent application in at least one dimension using at least one of an analogue tool, a 2-dimensional tool, a 3-dimensional tool, a virtual reality tool, or an augmented reality tool.

According to yet another embodiment, the processor is configured to embed the plurality of physical units of the IoT devices with at least one f electronics, software, actuators or network connectivity tools of the entity, wherein the plurality of physical units collects and communicates the at least one layer of information, wherein the plurality of physical units of the IoT devices are sensed or controlled remotely using the distributed network.

In an embodiment, the evaluation of the patent application value according to the evaluation scheme is based on the previously qualified, concrete exploitation scenario including the named influencing factors, opportunities and/or risks. The specific or possible assumptions of the patent applications are disclosed, so that the delimitation the payment flows and the determination of value potential of the patent application are comprehensible for third parties. The plausibility and validity of the valuation method is optimized by license factor within the margins customary in an industry.

The license value of the patent application is calculated by multiplying at least one of information associated with the patent application. The information includes cumulative revenue over time (Rt), cense rate under inclusion of all other factors and risks (Lr) and share of intellectual property rights in the product considered (A).

In an embodiment, the communication between users and the system and between computers may be improved or automated using the guiding principle of semantic Web, that is adopted for the handling of existing information in a company. Therefore, all existing information is automatically analyzed using statistical document clustering which uses low-frequency terms and meta information is generated for each piece of information, which represents a relationship of the information to the content and context ontologies. The procedure is applied to explicit information requirement formulations of a user. With regard to specific tasks, only parts of the overall ontologies are relevant. This way the user may be meta-indexed. The information supply is then realized by a matching process between the diverse meta information.

The advantages of this system are thus identical to those disclosed above in connection with the present method as described above and the embodiments listed above in connection with the present method as described above apply mutatis mutandis to the present method. In an example embodiment, the valuation of a patent based on an invention created by a Start-Up company to build a switch for a smart home system is provided. The company is in an early stage and the yield is less high than other means. The Patent is protecting an art/arear where the market trends are forecasting. The Start-Up knows that many companies may do research and development in the next years into that area and is paying the maintenance cost to keep the protection alive over time and in the relevant countries. However, today, the valuation of the patent may not still high as no other companies are in the area. Investors support with venture money the start-up, the valuation of the patent increases for the first time and as soon as other companies provide products in the field of the Start Up's invention, the valuation of the patent rises massively by the lifetime and a country of the patent and a market-based calculated license of the market revenue volume in that field of industry sector. The present system employs the machine learning algorithm for understanding the above scenario and determine the valuation of a patent which may be needed for investment analysis, capital budgeting, merger and acquisition transactions, financial reporting, taxable events to determine the proper tax liability, and in litigation.

The present system may process intangible assets to determine a valuation of a patent application. The intangible assets optionally comprise external factors or information affecting the valuation that includes at least one of ecological or economical impact, a composition of a company's shareholder portfolio, long and short-term partner relationships, co-innovation efforts, community cohesion, company culture, employee learning indices, media coverage, and legal elements for valuation of the business.

According to another embodiment, the at least one layer of information that is obtained from an information resource using a communication protocol information exchange over a distributed network. The information resource is selected from at least one of definition and kind, place, amount or rating. The at least one layer of information obtained from the plurality of information resources is processed using structural tools to convert it into a structured format.

Embodiments of the present disclosure may determine a valuation of a patent application of an entity using machine learning based on a dynamic representation of the patent application in at least one dimension.

Embodiments of the present disclosure may provide a holistic strategic valuation for the patent application in at least one dimension using the at least three layers of information. Embodiments of the present disclosure may dynamically update a valuation of the patent application by applying a machine learning algorithm to the machine learning model. The embodiments of the present disclosure may process information/external factors that impacts the valuation of the patent using the machine learning model for determining most accurate valuation for the patent. Embodiments of the present disclosure may eliminate the limitations in a valuation of a patent application of an entity using machine learning based on a dynamic representation of the patent application in at least one dimension.

### DETAILED DESCRIPTION OF THE DRAWINGS

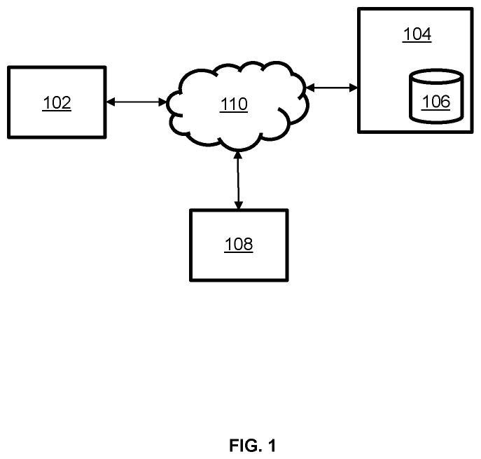

FIG. 1 is a schematic illustration of a system in accordance with an embodiment of the present disclosure. The system comprises a user device 102, a server 104, an expert device 108 and a communication network 110. The server 104 comprises a processor and a server database 106. The function of these parts as has been described above.

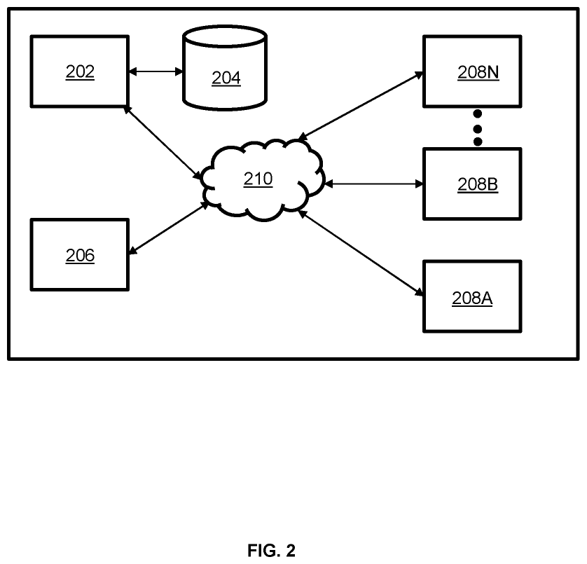

FIG. 2 is a schematic illustration of a system comprising a processor that generates a machine learning model in accordance with an embodiment of the present disclosure. The system comprises a processor 202, a database 204, an expert device 206 and an Internet of Thing devices 208A-208N. The function of these parts as has been described above.

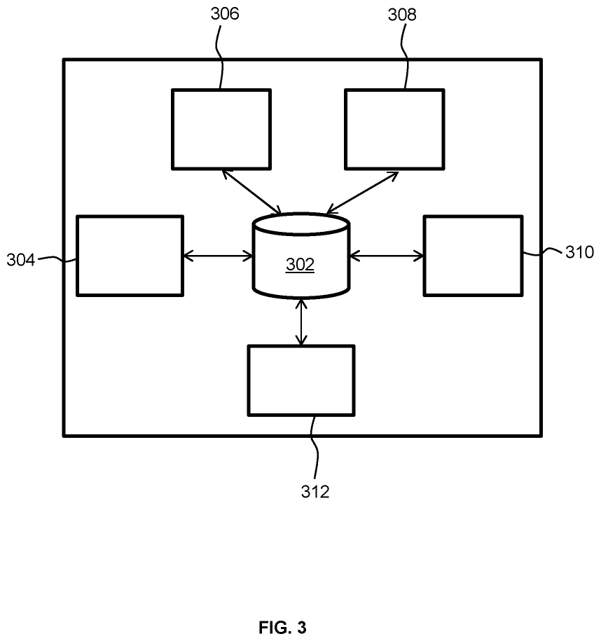

FIG. 3 is a functional block diagram of a server in accordance with an embodiment of the present disclosure. The functional block diagram of the server comprises a server database 302, a database generation module 304, a representation generation module 306, a patent comparison module 308, a user input processing module 310 and a patent valuation module 312. These modules function as has been described above.

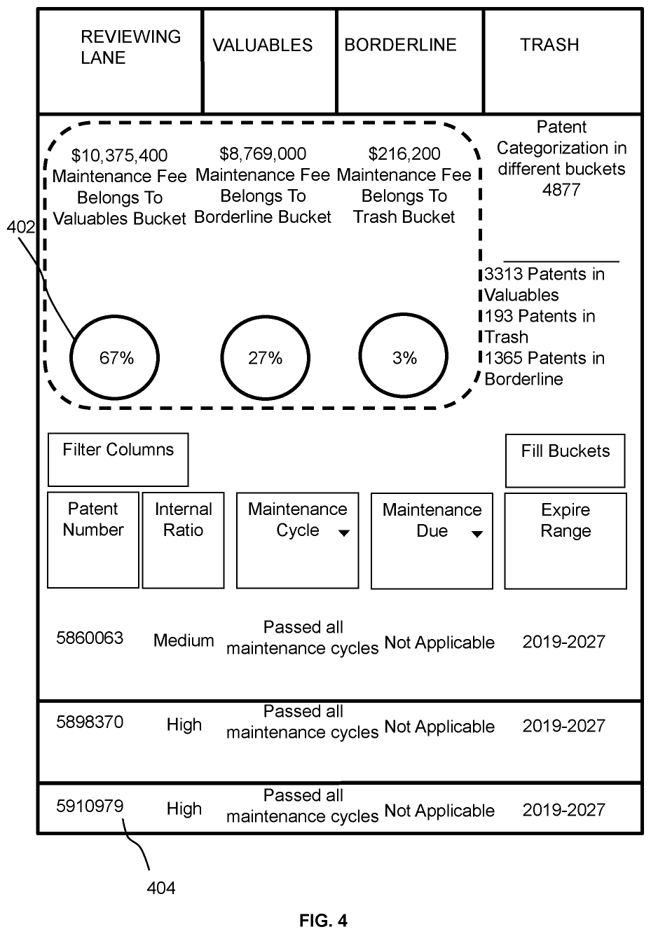

FIG. 4 is an exemplary view of a graphical user interface of a dynamic 3-dimensional image of a patent application in accordance with an embodiment of the present disclosure. The graphical user interface comprises a maintenance fee data field 402 and a patent portfolio field 404. The maintenance fee data field 402 depicts information related to the maintenance fee of patents of an entity. The patent portfolio field 404 depicts the maintenance fee queue of the patent portfolio of the entity.

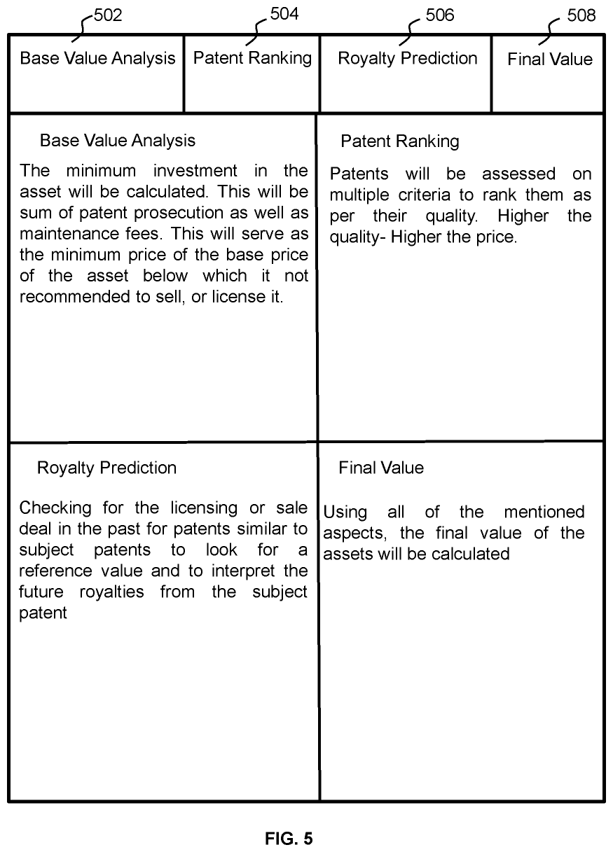

FIG. 5 is an exemplary view of a graphical user interface of valuation of a patent in accordance with an embodiment of the present disclosure. The graphical user interface comprises a base value analysis field 502, a patent ranking field 504, a royalty prediction field 506 and a final value field 508. The analysis field 502 comprises information related to a base value of a patent of an entity. The patent ranking 504 comprises information related to patent rankings of a patent portfolio of an entity. The royalty prediction field 506 comprises information related to a licensing or sale details of the patent of the entity. The final value field 508 comprises information related to a valuation of the patent of the entity.

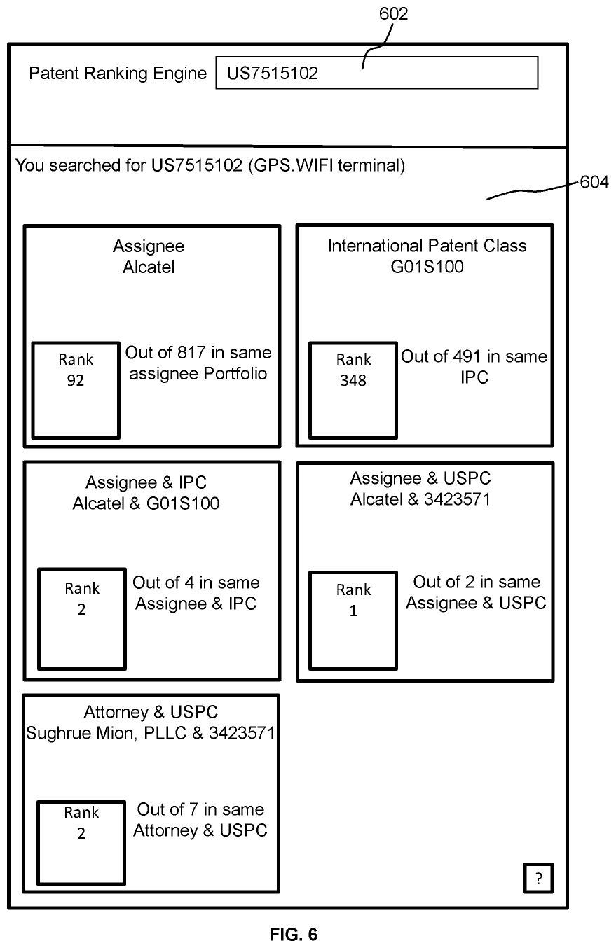

FIG. 6 is an exemplary view of a graphical user interface of a dynamic representation of a ranking of a patent in at least one dimension in accordance with an embodiment of the present disclosure. The graphical user interface comprises a search field 602 and a rank field 604. The search field 602 may provide an option to provide input to find a ranking of a patent using. The rank filed 604 comprises ranking information associated with the patent of an entity.

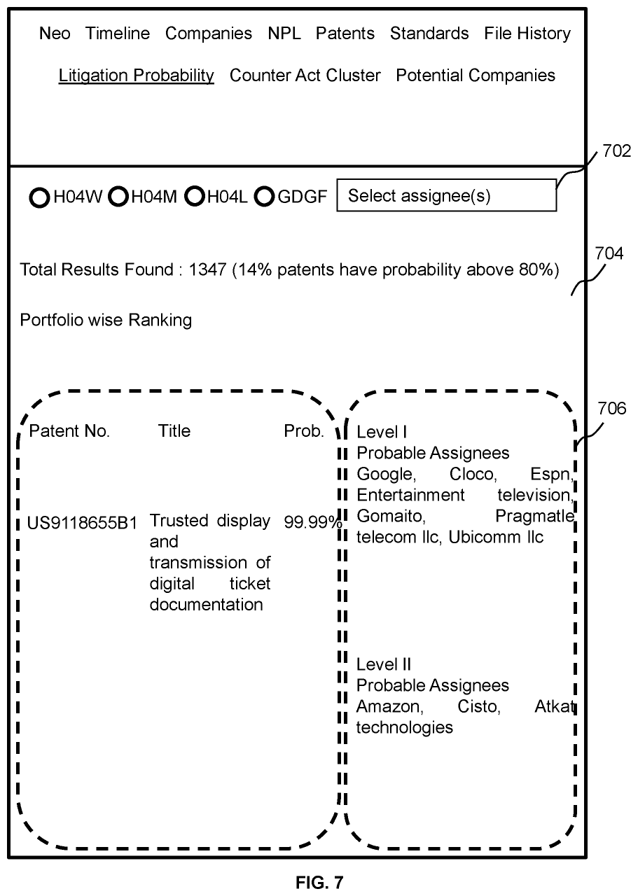

FIG. 7 is an exemplary view of a graphical user interface of a dynamic representation of a litigation probability of a patent in at least one dimension in accordance with an embodiment of the present disclosure. The graphical user interface comprises a search field 702, a result field 704 and a litigation information field 706. The search field 702 may provide an option to provide input to find a ranking of a patent. The result field 704 comprises results associated with the input provided in the search field 702. The litigation information field 706 comprises litigation details of the patent of an entity to be evaluated.

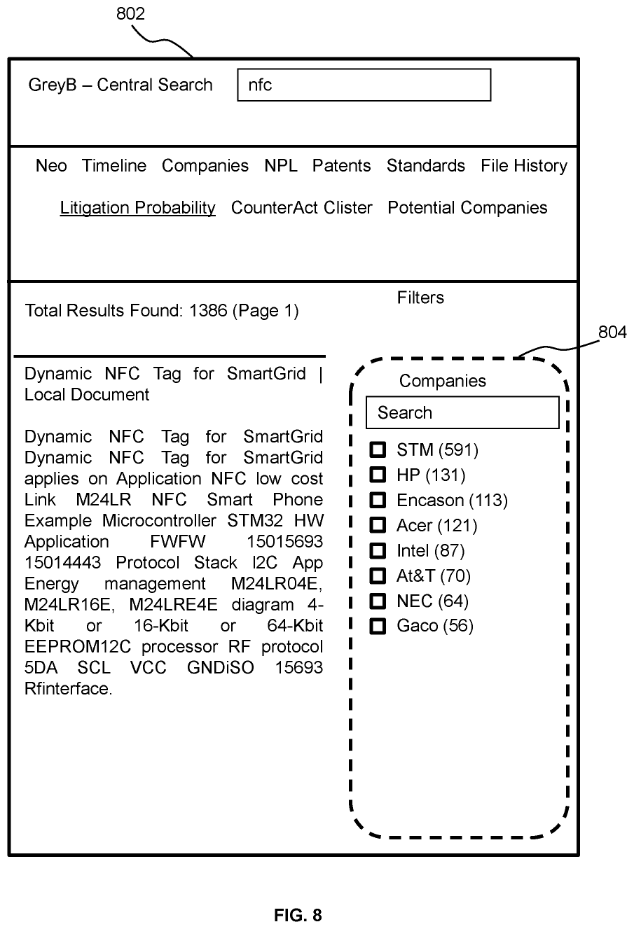

FIG. 8 is an exemplary view of a graphical user interface of a dynamic representation of litigation probability of a patent application to be evaluated in at least one dimension in accordance with an embodiment of the present disclosure. The graphical user interface comprises a search field 802 and a result field 804. The search field 802 may provide an option to provide input to find a litigation probability of a patent application. The result field 804 comprises results comprising the litigation probability of the patent application.

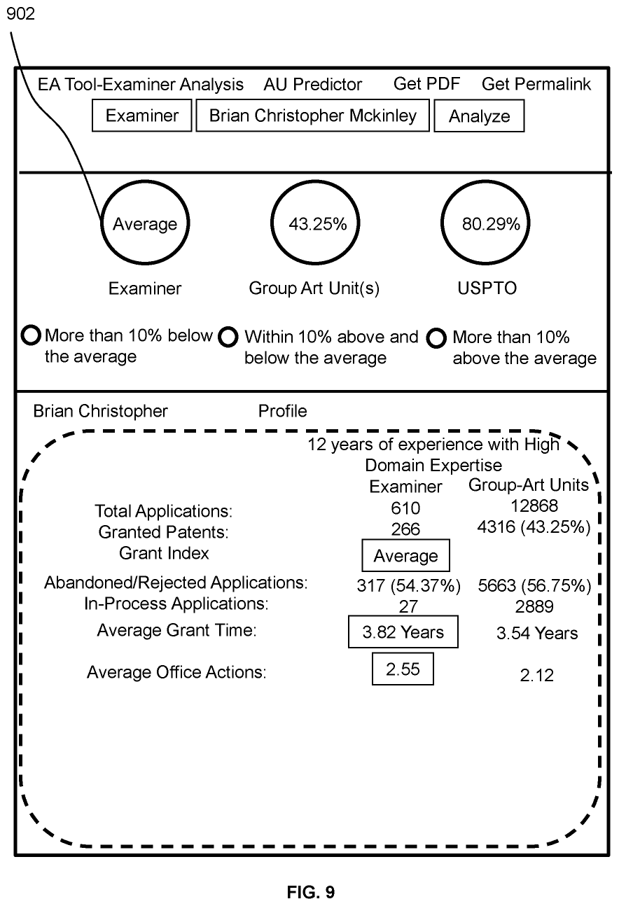

FIG. 9 is an exemplary view of a graphical user interface of a dynamic representation of an examiner analysis of a patent to be evaluated in at least one dimension in accordance with an embodiment of the present disclosure. The graphical user interface includes an examiner analysis field 902 that includes information associated with the examiner analysis of a patent of an entity.

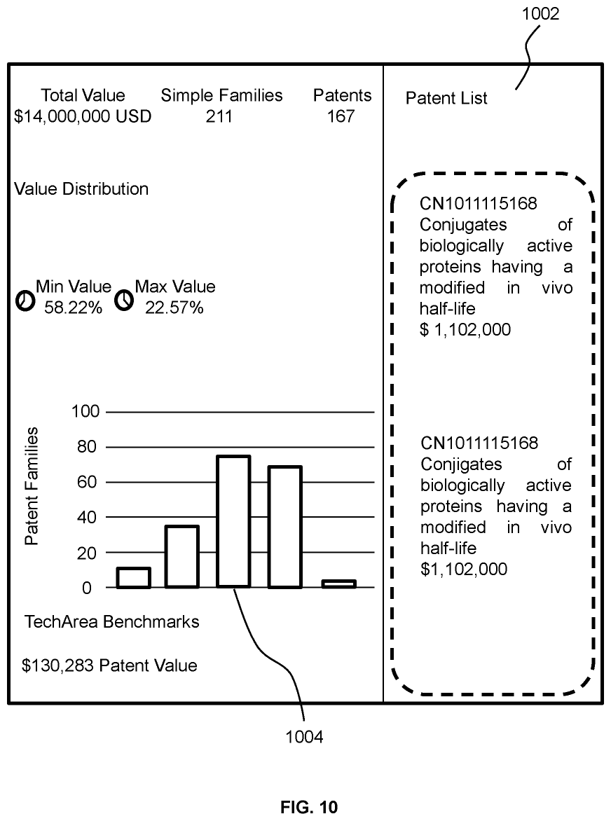

FIG. 10 is an exemplary view of a graphical user interface of a dynamic representation of a valuation of a patent family of a patent application to be evaluated in at least one dimension in accordance with an embodiment of the present disclosure. The graphical user interface includes a patent list field 1002 that shows a patent list associated with a valuation of a patent of an entity in the. The graphical user interface includes a value field 1004 that includes information of family patents and an area of technology associated with the patent of the entity.

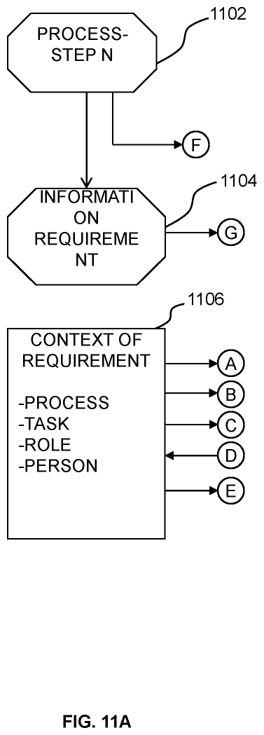

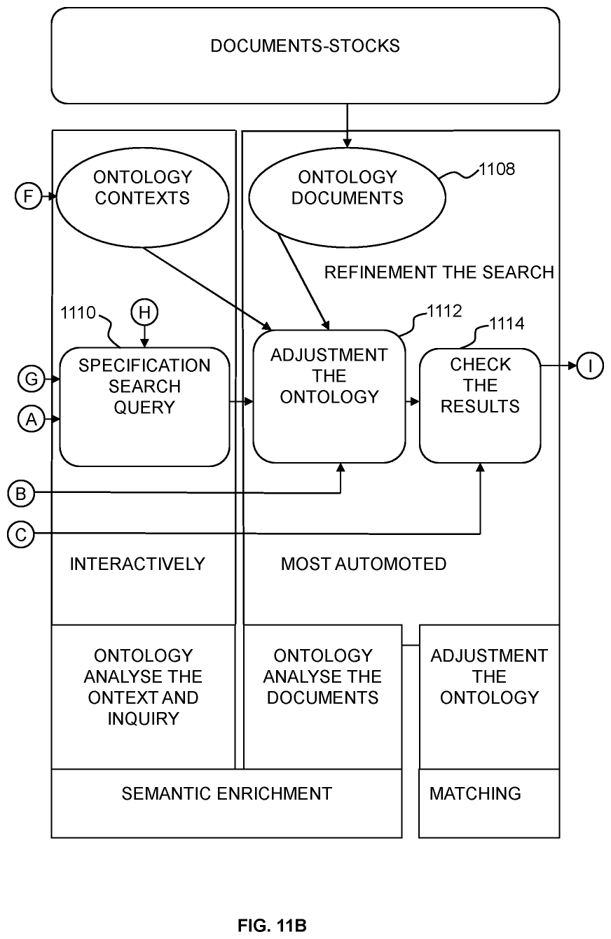

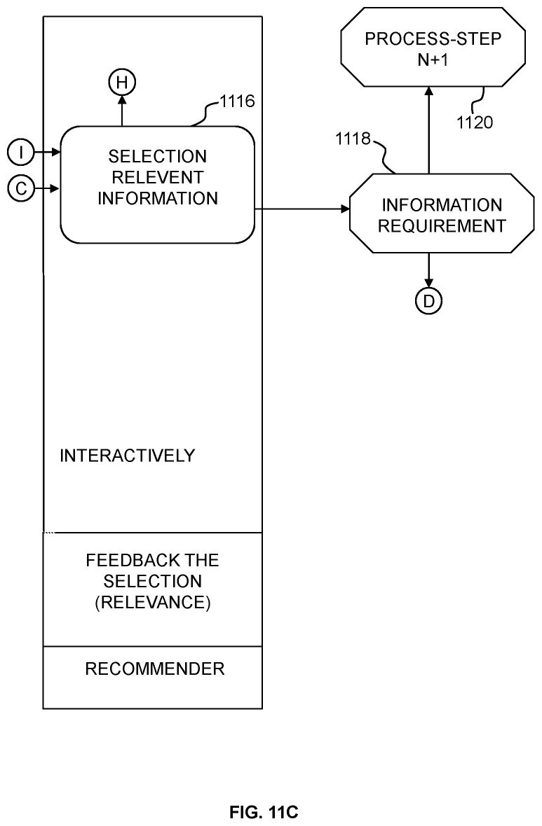

FIGS. 11A-11C are block diagrams illustrating a process of user interaction with the system in accordance with an embodiment of the present disclosure. At a step 1102, a process of user interaction with the system is started. In an embodiment, the process comprises N of steps. At a step 1104, an information required is received from the user. At a step 1106, context of requirement such as process, task, role, person is determined. At a step 1108, ontology documents are received. At a step 1110, a specification search query to be searched is received from the step 1104 and the step 1106. At a step 1112, the searches are matched to ontology contents and ontology documents. At a step 1114, the search results are checked. At a step 1116, relevant information is selected from the search results. At a step 1118, information required is received from the step 1106. At a step 1120, the process continues and the process comprises N+1 steps.

In an embodiment, the communication between the user and the system and between computers may be improved or automated using the guiding principle of semantic Web, that is adopted for the handling of existing information in a company. Therefore, all existing information is automatically analyzed using statistical document clustering which uses low-frequency terms and meta information is generated for each piece of information, which represents a relationship of the information to the content and context ontologies. The procedure is applied to explicit information requirement formulations of a user. With regard to specific tasks, only parts of the overall ontologies are relevant. This way the user may be meta-indexed. The information supply is then realized by a matching process between the diverse meta information

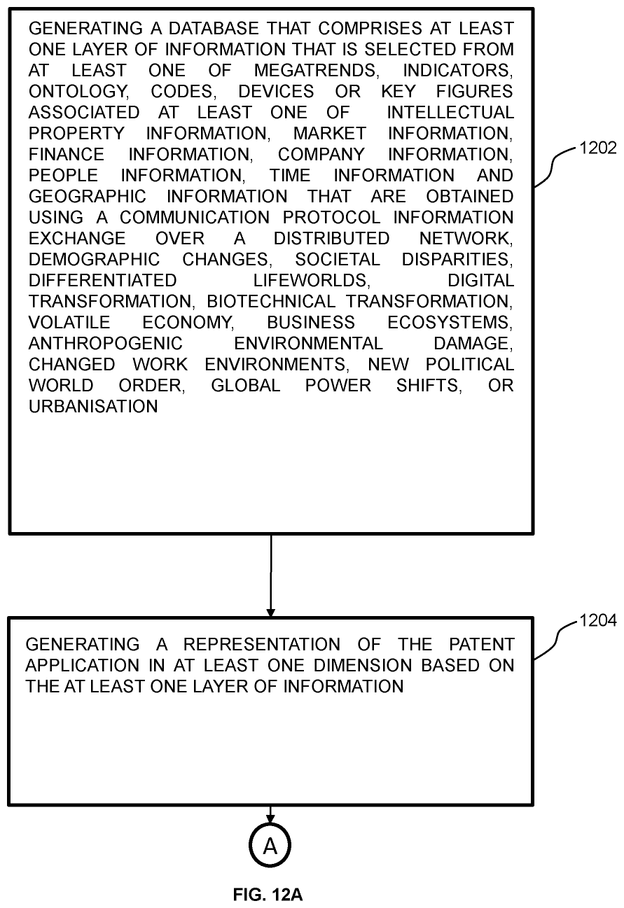

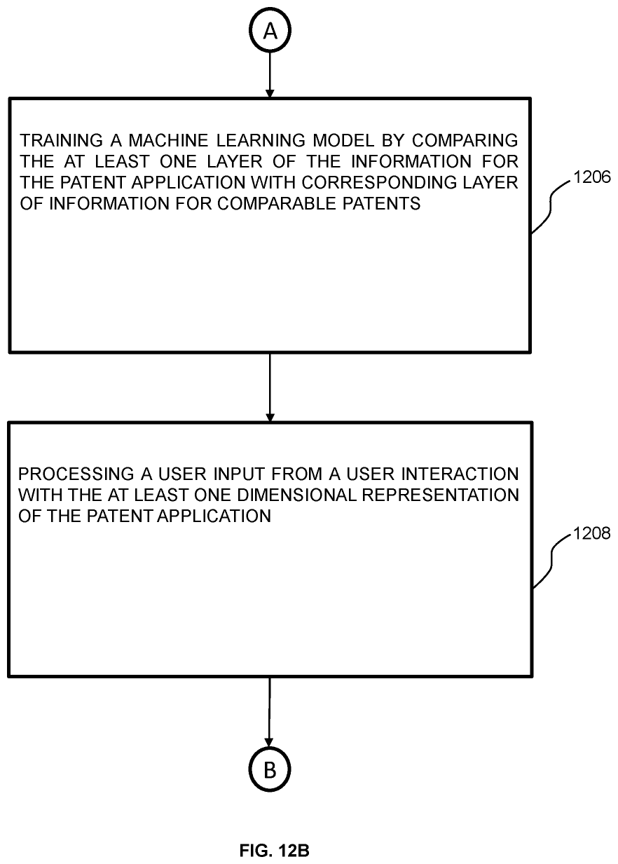

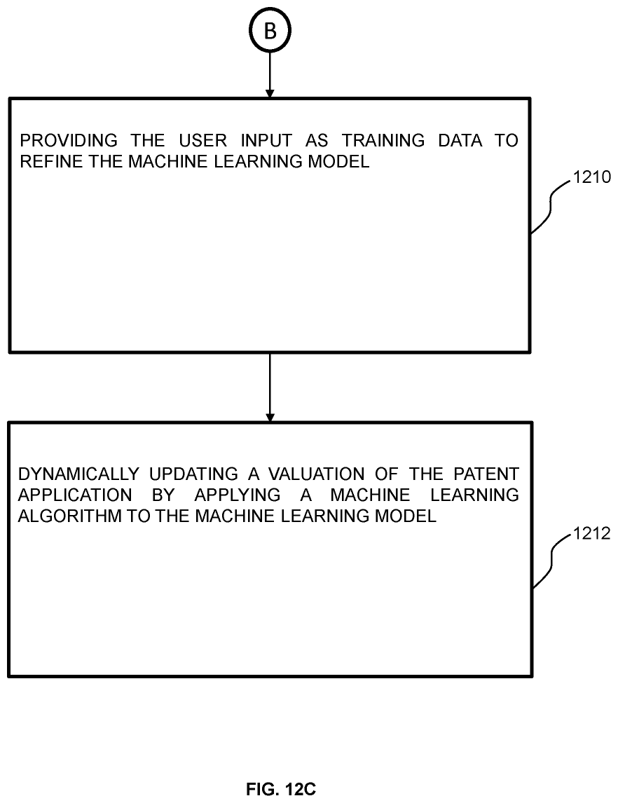

FIGS. 12A-12C are flow diagrams illustrating a method for semi-automated determination of a valuation of a patent application of an entity using machine learning based on a dynamic representation of the patent application in at least one dimension in accordance with an embodiment of the present disclosure. At a step 1202, a database that comprises at least one layer of information that is selected from at least one of megatrends, indicators, ontology, codes, devices or key figures associated at least one of Intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation is generated. At a step 1204, a representation of the patent application is generated in at least one dimension based on the at least one layer of information. At a step 1206, a machine learning model is trained by comparing the at least one layer of the information for the patent application with corresponding layer of information for comparable patents. At a step 1208, a user input from user interaction with the at least one dimensional representation of the patent application is processed. At a step 1210, the user input is provided as training data to refine the machine learning model. At a step 1212, a valuation of the patent application is dynamically updated by applying a machine learning algorithm to the machine learning model.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for semi-automated determination of a valuation of a patent application of an entity, the method comprising:
generating a database that comprises at least one layer of information that is selected from at least one of intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
generating a representation of the patent application in at least one dimension based on the at least one layer of information, wherein the representation of the patent application in the at least one dimension is generated using at least one of an analogue tool, a 2-dimensional tool, a 3-dimensional tool, a virtual reality tool, or an augmented reality tool, and wherein the at least one dimension is associated with megatrends, key figures and indicators;
training a machine learning model by comparing the layer of the information for the patent application with corresponding layer of information for comparable patents;
processing a user input from a user interaction with the at least one dimensional representation of the patent application;
providing the user input as training data to refine the machine learning model, wherein the machine learning model employs a training information and an expert input as the training data; and
dynamically updating the valuation of the patent application, when there is a change in the at least one layer of information, by applying a machine learning algorithm to the machine learning model, wherein the machine learning model is generated by:
generating a training information database with the training information associated with evaluated patents, wherein the training information comprises at least one of external factors, historical data, current data, plan data or differential data associated with the evaluated patents;
processing the expert input from a valuation expert on the training information associated with the evaluated patents, wherein the expert input comprises feedback associated with the training information associated with the evaluated patents; and
providing the training information associated with the evaluated patents and the expert input to the machine learning algorithm as training data to generate the machine learning model.

2. The method according to claim 1, characterized in that the at least one layer of information is obtained from a plurality of information resources by performing:
connecting a plurality of physical units of Internet Of Things (IoT) devices with the plurality of information resources for collecting the at least one layer of information;
recording the at least one layer of information from the plurality of information resources; and
processing the at least one layer of information to generate the database.

3. (canceled)

4. (canceled)

5. The method according to claim 2, characterized in that the method comprises embedding the plurality of physical units of the IoT devices with at least one of electronics, software, actuators or network connectivity tools of the entity, wherein the plurality of physical units collects and communicates the at least one layer of information, wherein the plurality of physical units of the IoT devices are sensed or controlled remotely using the distributed network.

6. A system comprising a server for determining a valuation of a patent application of an entity, the system comprising:
a processor; and
a memory configured to store program codes comprising:
a database generation module that generates a database that comprises at least one layer of information that is selected from at least one of intellectual property information, market information, finance information, company information, people information, time information and geographic information that are obtained using a communication protocol information exchange over a distributed network, demographic changes, societal disparities, differentiated lifeworlds, digital transformation, biotechnical transformation, volatile economy, business ecosystems, anthropogenic environmental damage, changed work environments, new political world order, global power shifts, or urbanisation;
a representation generation module that generates a representation of the patent application in at least one dimension based on the at least one layer of information, wherein the representation of the patent application in the at least one dimension is generated using at least one of an analogue tool, a 2-dimensional tool, a 3-dimensional tool, a virtual reality tool, or an augmented reality tool, and wherein the at least one dimension is associated with megatrends, key figures and indicators;
a patent comparison module that trains a machine learning model by comparing the at least one layer of the information for the patent application with corresponding layer of information for comparable patents;
a user input processing module that processes a user input from a user interaction with the at least one dimensional representation of the patent application, wherein the user input processing module provides the user input as training data to refine the machine learning model, wherein the machine learning model employs a training information and an expert input as the training data, wherein the machine learning model is generated by the processor that is configured to:
generate a training information database with the training information associated with evaluated patents, wherein the training information comprises at least one of external factors, historical data, current data, plan data or differential data associated with the evaluated patents;
process the expert input from a valuation expert on the training information associated with the evaluated patents, wherein the expert input comprises feedback associated with the training information associated with the evaluated patents; and
provide the training information associated with the evaluated patents and the expert input to the machine learning algorithm as training data to generate the machine learning model;
a patent valuation module that dynamically updates the valuation of the patent application, when there is a change in the at least one layer of information, by applying the machine learning algorithm to the machine learning model.

7. The system according to claim 6, characterized in that the processor obtains the at least one layer of information from a plurality of information resources by performing:
connecting a plurality of physical units of Internet of Things (IoT) devices with the plurality of information resources for collecting the at least one layer of information;
recording the at least one layer of information from the plurality of information resources; and
processing the at least one layer of information to generate the database.

8. (canceled)

9. The system according to claim 7, characterized in that the processor further configured to embed the plurality of physical units of the IoT devices with at least one of electronics, software, actuators or network connectivity tools of the entity, wherein the plurality of physical units collects and communicates the at least one layer of information, wherein the plurality of physical units of the IoT devices are sensed or controlled remotely using the distributed network.
